(19) United States
(12) Patent Application Publication
(10) Pub. No.: US 2015/0032720 A1
(43) Pub. Date: Jan. 29, 2015

(54) OPTIMIZING DATABASE QUERIES

(71) Applicant: Yahoo! Inc., Sunnyvale, CA (US)

(72) Inventor: Rick James, Los Altos, CA (US)

(73) Assignee: Yahoo! Inc., Sunnyvale, CA (US)

(21) Appl. No.: 13/948,610

(22) Filed: Jul. 23, 2013

(51) Int. Cl. G06F 17/30

(52) U.S. Cl. CPC G06F 17/30442; G06F 17/30289
USPC 707/713; 707/802

(57) ABSTRACT

A system and method for database management and accessing data stored in the database may be optimized based on the database structure. For example, data associated with a range (e.g. owners of IP addresses) may have query requests optimized by utilizing two tables. The first table may include all the ranges, such that the ranges are continuous and not overlapping, and an identifier for each of the ranges. The second table may include the identifiers and the data that is associated with the range corresponding with those identifiers. Query requests for a particular range may be optimized by utilizing specialized database queries for the first table and because the data associated with the range is not part of the first table. Further, the second table size is reduced because an identifier may be associated with multiple ranges.

### BACKGROUND

Databases may be used to store data. The data may include tables with metadata and associated data. Indexing of very large databases is necessary for accessing and managing the data. For certain data sets, the amount of data may be so large that performance of the database degrades because accessing data within a very large database requires significant processing. The processing required may result in performance degradation of both managing the database and merely accessing data from the database. Even with modified indexing, the accessing of data may still be an order(n) operation.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a diagram of an exemplary network system;

FIG. 2 is a diagram of an exemplary optimizer;

FIG. 3 is a diagram of exemplary tables; and

FIG. 4 illustrates exemplary optimized functions.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

By way of introduction, database structure may be modified to optimize the management and accessing of the database. For example, data associated with a range (e.g. owners of IP addresses) may have query requests optimized by utilizing two tables. The first table may include all the ranges, such that the ranges are continuous and not overlapping, and may include a non-unique identifier for each of the ranges. The second table may include the identifiers and the data that is associated with the range corresponding with those identifiers. Query requests for a particular range may be optimized by utilizing specialized database queries for the first table and because the data associated with the range is not part of the first table. Further, the second table size is reduced because an identifier may be associated with multiple ranges because the identifiers for the ranges in the first table are not unique and may be repeated.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

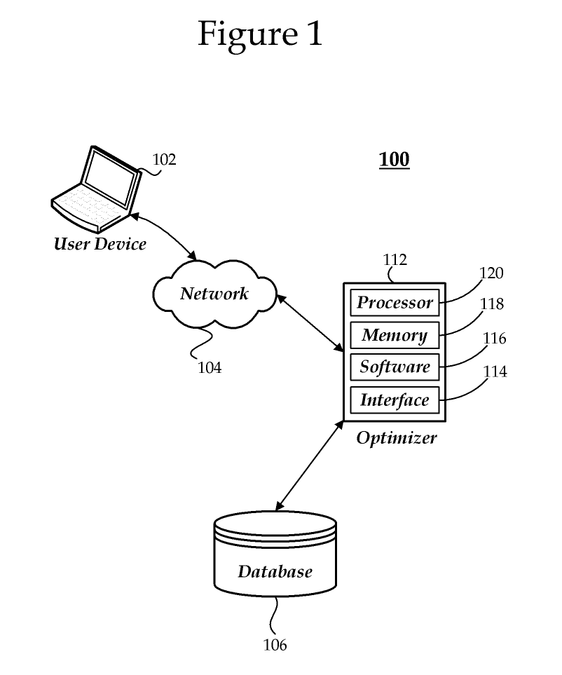

FIG. 1 depicts a block diagram illustrating one embodiment of an exemplary network system 100. The network system 100 may provide a platform for managing a database and accessing data from that database. In the network system 100, a user device 102 is coupled through a network 104 with an optimizer 112 and/or a database 106. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided. Accordingly, the optimizer 112 may be coupled directly or through a network (e.g. the network 104) with the database 106. In alternative embodiments, the optimizer 112 may be a part of the database 106. Likewise, the optimizer 112 may be part of the user device 102.

The user device 102 may be a computing device which allows a user to connect to a network 104, such as the Internet. The user device 102 may provide an interface for modifying/accessing the database 106. In addition, the user device 102 may provide an interface for accessing/controlling the optimizer 112. The user device 102 may also be referred to as a client device and may include a computing device capable of sending or receiving signals, such as via a wired or a wireless network (e.g. the network 104, which may be the Internet). The user device 102 may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. The user device 102 may include or may execute a variety of operating systems, including a personal computer operating system, such as a Windows, iOS or Linux, or a mobile operating system, such as iOS, Android, or Windows Mobile, or the like. The user device 102 may include or may execute a variety of possible applications, such as database management programs that may manage the database 106 with or without the optimizer 112. In one embodiment, the user device 102 is configured to request and receive information from a network (e.g. the network 104, which may be the Internet). The information may include management instructions for the database 106 and/or query requests to the database 106.

The database 106 may be coupled with the optimizer 112 and/or the user device 102 or other devices. The database 106 may be any device that stores data, such as a memory. For example, a computing device with a memory may be a database that stores data. The data that is stored may be referred to as metadata to the extent that is data about other data. For example, the database index (which may be referred to as identifiers in one embodiment) may be data, while data that is associated with the index may be metadata.

Although not shown, the optimizer 112 may include or act as a server. Likewise, the database 106 may be coupled with a server for communicating with other devices (e.g. the user device 102). The server may be a computing device which may be capable of sending or receiving signals, such as via a wired or wireless network, or may be capable of processing or storing signals, such as in memory as physical memory states. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

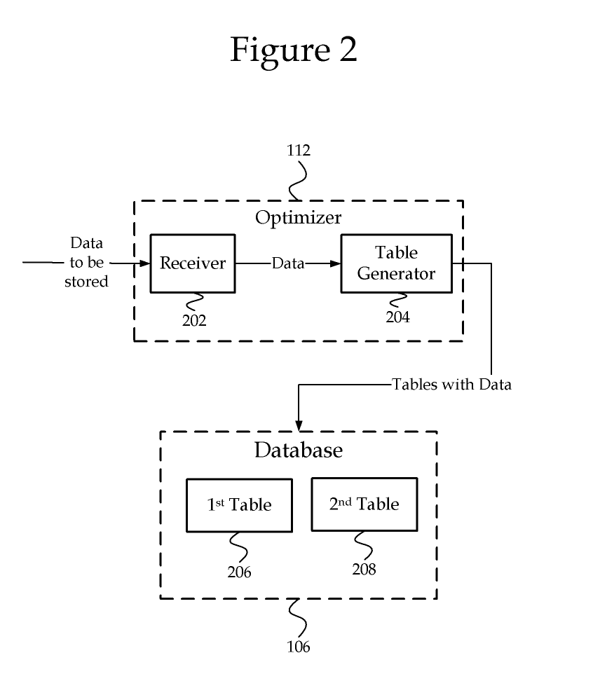

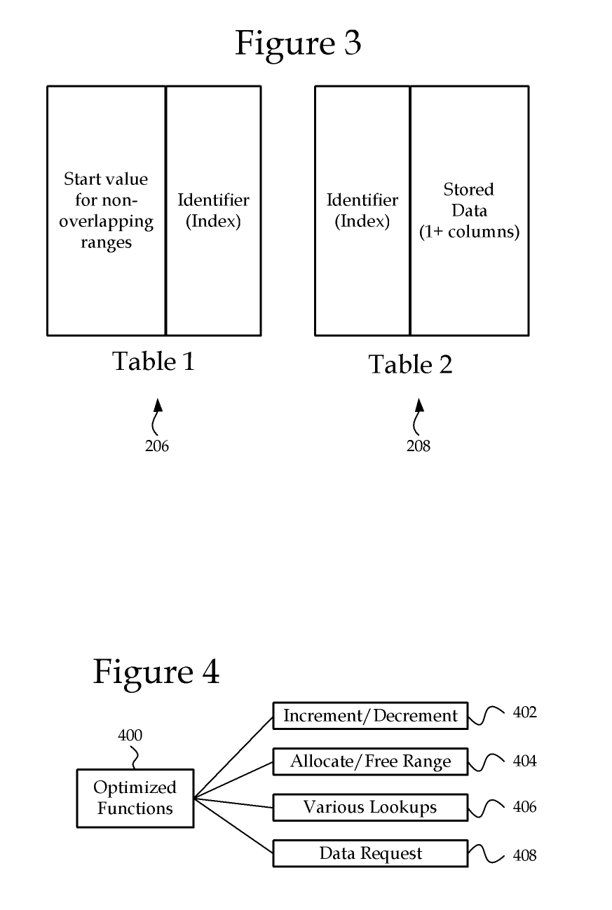

The optimizer 112 may perform at least two main functions. First, the optimizer 112 may generate optimize the database by generating tables (discussed below with respect to FIGS. 2-3). Second, the optimizer 112 may improve query requests and/or management of the database using the generated tables. In one embodiment, the optimizer 112 may be part of the database 106 or may be part of the user device 102. Alternatively, the optimizer 112 may be part of a separate entity. The optimizer 112 is further described with respect to FIG. 2. The optimizer 112 may be a computing device for generating tables for the database and optimizing management and accessing of those tables. The optimizer 112 may be part of the database 106 and may include more or fewer components than illustrated in the network system 100. In particular, the optimizer 112 may execute the functions discussed with respect to FIG. 4 and may perform query requests of the database 106.

The optimizer 112 may include a processor 120, memory 118, software 116 and an interface 114. The interface 114 may communicate with the user device 102 and/or the database 106. The interface 114 may include a user interface configured to allow a user and/or administrator to interact with any of the components of the optimizer 112. In one embodiment, the user device 102 may act as the interface for the database 106.

The processor 120 in the optimizer 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with a memory 118, or the memory 118 may be a separate component. The interface 114 and/or the software 116 may be stored in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded ad or user data. Examples include a hard drive, compact disc (“CD”), digital video disc (“DVD”), memory card, memory stick, floppy disc, universal serial bus (“USB”) memory device, or any other device operative to store ad or user data. The memory 118 is operable to store instructions executable by the processor 120. In one embodiment, the memory 118 may be the database 106 although FIG. 1 illustrates the database 106 as a separate entity in another embodiment.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116. The software 116 may include instructions for managing the database 106 and accessing data from the database 106.

The interface 114 may be a user input device for accessing/managing the database 106. The interface 114 may include a keyboard, keypad or a cursor control device, such as a mouse, or a joystick, touch screen display, remote control or any other device operative to interact with the optimizer 112. The interface 114 may include a display coupled with the processor 120 and configured to display an output from the processor 120. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for the database 106.

The present disclosure contemplates a computer-readable medium that includes instructions or receives and executes instructions responsive to a propagated signal, so that a device connected to a network can communicate voice, video, audio, images or any other data over a network. The interface 114 may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly. Any of the components in the network system 100 may be coupled with one another through a network, including but not limited to the network 104. For example, the optimizer 112 may be coupled with the database 106 and/or the user device 102 through a network. Accordingly, any of the components in the network system 100 may include communication ports configured to connect with a network, such as the network 104.

The network (e.g. the network 104) may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example. For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

The network connecting the devices described above (e.g. the network 104) may be a “content delivery network” or a “content distribution network” (CDN). A CDN generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

FIG. 2 is a diagram of an exemplary optimizer 112 communicating with the database 106. The optimizer 112 may include a receiver 202 for receiving data to be stored in the database 106. The data to be stored may be referred to as metadata, relevant data, or storage data. That data is then parsed by a table generator 204. The table generator 204 stores the data in a table. In one embodiment, the optimization of the database 106 includes generating two tables, a first table 206 and a second table 208 which are described with respect to FIG. 3. The first table 206 may be referred to as an index table or a lookup table, while the second table 208 may be referred to as the data table. In an alternative embodiment, the two tables are stored in separate databases.

FIG. 3 is a diagram of exemplary tables. In particular, FIG. 3 illustrates the first table 206 and the second table 208. As described, this optimization may apply to ranges and the related stored data (e.g. metadata) related to those ranges, which may include IP addresses in one embodiment as described herein. The ranges may be a group with no overlap; however, the representation of the range in the first table is with a single value (e.g. first value of the range or last value of the range) rather than the entire range or rather than multiple values for the range. Further, the ranges are continuous from entry to entry with no overlap. Each of the ranges are represented by a starting value of the range or in a different embodiment, the range may be represented by an ending value of the range. Each of the ranges corresponds with an identifier which acts as an index value for associating the relevant stored data with the range. The identifier may also be a link that links from the first table 206 to the second table 208. In other words, FIG. 3 illustrates that a single table of ranges in one column and the stored data (for each range) in a second column is split into two tables. In order to maintain continuity in the first table there may be zero values for the identifier column for ranges that do not have associated data. In alternative embodiments, the zero values may be referred to as null or empty values, but represent an instance where a range does not have associated data (i.e. has a zero value or zero data). Those ranges are included for the first table to maintain continuity for the ranges. There may multiple ranges that have the same identifier when those ranges are associated with the same stored data. Accordingly, the number of entries (number of rows) in table 2 are smaller because of the zero value rows from table 1 along with ranges that share the same identifier. In alternative embodiments, the second table may include a large number of columns of stored data. The first table operates as an index that can be used to locate stored data more effectively.

Because the first table includes non-overlapping and continuous ranges, the accessing of the stored data may be an order(1) or an order(log(n)) operation. In one embodiment, the optimization and improved performance may be through using a B-Tree or Btree algorithm for accessing data from the database. B-Tree may be an exemplary “indexing” method, which may embody the access algorithms, and the structure of the information in the “index.” As described, the algorithms (and efficiencies gained by the algorithms) may be based on utilization of B-tree, but embodiments other than B-tree may be implemented to the same effect. Certain database engines (e.g. MySQL) may tend to use B-Tree, which is why it is described herein, but it is merely one of many potential indexing options. The structure of the first table 206 discussed above results in using a Btree index for a lookup operation, which is an order(1) or an order(log(n)) operation. In addition, the Btree also allows for efficiencies in moving forward or backward within the range entries. Accordingly, the attributes of the Btree include efficient lookup of any particular entry and efficient locating of adjacent entries. Btree is merely one example and other operations other than Btree index type may be utilized and provide an optimized performance.

In one embodiment, the database may be implemented with MySQL® which utilizes a primary key as an index. In the tables shown in FIG. 3, the column with the ranges may be the primary key for the first table because the value is unique. For the second table, the column with the identifiers may be the primary key.

One example of data stored in the tables that includes ranges are internet protocol (“IP”) addresses. A range of IP addresses may be include different features. For example, table 2 may include columns of data for the IP address range owner, service provider, geographic location, user, or other “data” about a set of ranges of IP addresses. The description with respect to FIG. 4 describes IP address ranges as one example and includes exemplary code for performing functions using IP addresses (both IPv4 and IPv6); however, IP address storage in a database is merely one exemplary implementation of the database optimization discussed herein. Another example may be a database of television programming where the range is the time and the stored data may include the name of the show and other information about the show. Likewise, the range may be channels and the stored data include the owner or provider of those channels.

FIG. 4 illustrates exemplary optimized functions 400. The exemplary optimized functions 400 may be embodied in stored routines. Exemplary code is shown below for an IP address database; however, this is merely one example of how the functions may operate. Further, there are two IP address implementations discussed below. IPv4 is 32 bit and includes IP addresses such as 196.168.1.255. IPv6 is 128 bit and includes significantly more IP addresses and more entries. However, those large ranges of IPv6 addresses that are unassigned may be null or zero values in the first table and have no representation in the second table.

The exemplary optimized functions 400 include incrementing and decrementing an entry 402. A range may be allocated or freed 404 as another function. Other lookups may also be performed 406, along with other data requests 408. Specific implementations (for the IP address exemplary embodiment) are shown below with exemplary code.

IPv4 Reference Implementation:

The first table is identified as “Ips” and includes “ip” as the first column (e.g. one value from a range of IP addresses, which in this exemplary embodiment is the starting value of the range, but could be an ending value of the range in another embodiment) and the identifier is labeled as “owner.” The “ip” values are INT UNSIGNED, the “owner” values are MEDIUMINT UNSIGNED (0=no owner) and ip+1 and ip−1 are simple arithmetic.

Rules for “ip” values include:

A NULL value for ip means “greater than 0xFFFFFFFF.”

A “block” of ip addresses is represented by the start and end values,

By convention, owner=0 means “not owned by anyone” or “free”.

There may be no way for the table to represent overlapping blocks, hence such is disallowed.

ALL ip addresses are ALWAYS in the Ips table.

INET_ATON( ) and INET_NTOA( ) may be used by the caller, if desired.

Rules for “owner” values include:

“owner” is the PRIMARY KEY in the second table.

The main table (Ips) contains one row per block of owned (or free) IP addresses.

Generation of the table: (in MySQL dialect)

```
CREATE TABLE Ips (
  ip INT UNSIGNED NOT NULL COMMENT ‘IPv4 starting address’,
  owner MEDIUMINT UNSIGNED NOT NULL COMMENT ‘0=not
  owned; Join to another table to get info on owner’,
  PRIMARY KEY(ip),
  INDEX(owner) -- for finding range(s) owned
) ENGINE=InnoDB;
-- The table MUST be initialized with the starting IP and owner=0:
-- INSERT INTO Ips (ip, owner) VALUES (0, 0);
-- InnoDB was deliberately chosen -- for the ‘clustering’.
DELIMITER //
```

The following routines/functions (adding one to an IP and subtracting one to an IP) may also be referred to as incrementing and decrementing, respectively. They may be used when the algorithm needs to find the “next” or “previous” value of an IP. For example, the “end” of one IP range is one less than the “start” of the next IP range. The IpIncr and IpDecr functions are used for such arithmetic. The functions are encapsulated rather than having the code simply used where it is needed. The encapsulation may be most useful when “increment” and “decrement” are more complex, (such as with the 128-bit IPv6 numbers).

Adding one to an IP:

```
DROP FUNCTION IF EXISTS IpIncr //
CREATE DEFINER = \grave{ }ip\grave{ }@\grave{ }localhost\grave{ } FUNCTION IpIncr(
    _ip INT UNSIGNED
  ) RETURNS INT UNSIGNED
  DETERMINISTIC
CONTAINS SQL -- SQL but does not read or write
BEGIN
  IF (_ip = 4294967295) THEN
    RETURN NULL;
  ELSE
    RETURN _ip + 1;
  END IF;
END //
```

Subtracting one to an IP:

```
-- (Please do not feed 0 in)
DROP FUNCTION IF EXISTS IpDecr //
CREATE DEFINER = \grave{ }ip\grave{ }@\grave{ }localhost\grave{ } FUNCTION IpDecr(
    _ip INT UNSIGNED
  ) RETURNS INT UNSIGNED
  DETERMINISTIC
CONTAINS SQL -- SQL but does not read or write
BEGIN
  IF (_ip IS NULL) THEN
    RETURN 4294967295;
  ELSE
    RETURN _ip − 1;
  END IF;
END //
```

Assigning a range of IP addresses to an owner:

```
-- 1-7 SQL statements executed; most hit only one row.
-- To ‘free’ up a block, assign it owner=0.
DROP PROCEDURE IF EXISTS IpStore //
CREATE DEFINER = \grave{ }ip\grave{ }@\grave{ }localhost\grave{ } PROCEDURE IpStore(
    IN _ipa INT UNSIGNED,
    IN _ipz INT UNSIGNED,
    IN _new_owner MEDIUMINT UNSIGNED)
BEGIN
  DECLARE _ip INT UNSIGNED;
  DECLARE _owner MEDIUMINT UNSIGNED;
  DECLARE _next INT UNSIGNED DEFAULT IpIncr(_ipz);
  IF (_next IS NULL) THEN
    -- _ipz must be ff...ff; prep for later
    SELECT ip, owner INTO _ip, _owner FROM Ips WHERE ip <= _ipz ORDER BY
ip DESC LIMIT 1;
  ELSE
    -- Deal with point just off the end (_next):
    SELECT ip, owner INTO _ip, _owner FROM Ips WHERE ip <= _next ORDER BY
ip DESC LIMIT 1;
    IF (_ip = _next) THEN
      -- No gap before next block, so may need to coalesce:
      IF (_owner = _new_owner) THEN -- Merge with new entry
        DELETE FROM Ips WHERE ip = _next;
      END IF;
      SELECT ip, owner INTO _ip, _owner FROM Ips WHERE ip <= _ipz ORDER
BY ip DESC LIMIT 1;
    ELSE
      -- Assign gap:
      IF (_owner != _new_owner) THEN
        INSERT INTO Ips (ip, owner) VALUES (_next, _owner);
      END IF;
    END IF;
  END IF;
  -- Gut the middle (if needed):
  IF (_ip > _ipa) THEN
    DELETE FROM Ips WHERE ip > _ipa AND ip <= _ipz;
    SELECT ip, owner INTO _ip, _owner FROM Ips WHERE ip <= _ipa ORDER BY
ip DESC LIMIT 1;
  END IF;
  -- Deal with start of this block
  IF (_owner != _new_owner) THEN
    IF (_ip = _ipa) THEN
      SELECT owner INTO _owner FROM Ips WHERE ip < _ipa ORDER BY ip
DESC LIMIT 1;
      IF (_owner = _new_owner) THEN
        DELETE FROM Ips WHERE ip = _ipa; -- merge
      ELSE
        UPDATE Ips SET owner = _new_owner WHERE ip = _ipa; -- change
      END IF;
    ELSE
      INSERT INTO Ips (ip, owner) VALUES (_ipa, _new_owner); -- split
    END IF;
  END IF;
END //
```

Given a single IP address, find the owner:

```
-- Result may be 0 (un-owned), but will not be NULL.
DROP FUNCTION IF EXISTS IpOwner //
CREATE DEFINER = \grave{ }ip\grave{ }@\grave{ }localhost\grave{ } FUNCTION IpOwner(
    _ip INT UNSIGNED)
  RETURNS MEDIUMINT UNSIGNED
BEGIN
  DECLARE _owner MEDIUMINT UNSIGNED;
  SELECT owner INTO _owner
    FROM Ips
    WHERE ip <= _ip
    ORDER BY ip DESC
    LIMIT 1;
  RETURN _owner;
END //
```

Given a range of IP addresses, find all the owners:

```
-- This can be used before assigning a block - to see if someone else owns
any of the block.
-- Check the output for containing any ‘owner’ other than the desired
owner and ‘0’.
DROP PROCEDURE IF EXISTS IpRangeOwners //
CREATE DEFINER = \grave{ }ip\grave{ }@\grave{ }localhost\grave{ } PROCEDURE IpRangeOwners(
    IN _ip_start INT UNSIGNED,
    IN _ip_end INT UNSIGNED)
-- _ip_start is start of the range
-- _ip_next is the addr after the end of the range (or NULL when wanting
to end at fff...)
-- Resultset has one owner per row, dedupped.
BEGIN
  ( SELECT owner
    FROM Ips
    WHERE ip <= _ip_start
    ORDER BY ip DESC
    LIMIT 1 )
  UNION DISTINCT
  ( SELECT owner
    FROM Ips
    WHERE ip > _ip_start
      AND ip <= _ip_end );
END //
```

Given a range of IP addresses, find blocks and owners:

```
DROP PROCEDURE IF EXISTS IpFindRanges //
CREATE DEFINER = \grave{ }ip\grave{ }@\grave{ }localhost\grave{ } PROCEDURE IpFindRanges(
    IN _ip_start INT UNSIGNED,
    IN _ip_end INT UNSIGNED)
-- _ip_start is start of the range
-- _ip_next is the addr after the end of the range (or NULL when wanting
to end at fff...)
-- Resultset contains array of [starting IP, owner]
-- First IP will be <= _ip_start, and may be strictly <.
-- Owners with disjoint blocks will show up multiple times.
BEGIN
  ( SELECT ip, owner
    FROM Ips
    WHERE ip <= _ip_start
    ORDER BY ip DESC
    LIMIT 1 )
  UNION ALL
  ( SELECT ip, owner
    FROM Ips
    WHERE ip > _ip_start
      AND ip <= _ip_end
    ORDER BY ip )
  ORDER BY ip;
END //
```

Given an IP, find the start of the next block:

```
-- Returns NULL if runs off end of the address space.
DROP FUNCTION IF EXISTS IpNext //
CREATE DEFINER = \grave{ }ip\grave{ }@\grave{ }localhost\grave{ } FUNCTION IpNext(
    _ipa INT UNSIGNED
  ) RETURNS INT UNSIGNED
  DETERMINISTIC
CONTAINS SQL -- SQL but does not read or write
BEGIN
  DECLARE _ip_next INT UNSIGNED;
  SELECT ip INTO _ip_next
    FROM Ips
    WHERE ip > _ipa
    ORDER BY ip
    LIMIT 1;
  RETURN _ip_next;
END //
```

Given an IP, find the end of the block containing the IP:

```
DROP FUNCTION IF EXISTS IpEnd //
CREATE DEFINER = \grave{ }ip\grave{ }@\grave{ }localhost\grave{ } FUNCTION IpEnd(
    _ipa INT UNSIGNED
  ) RETURNS INT UNSIGNED
  DETERMINISTIC
CONTAINS SQL -- SQL but does not read or write
BEGIN
  DECLARE _ip_next INT UNSIGNED;
  SELECT ip INTO _ip_next
    FROM Ips
    WHERE ip > _ipa
    ORDER BY ip
    LIMIT 1;
  RETURN IpDecr(_ip_next);
END //
```

Given an owner, find the starting IP for each block it owns:

```
-- Resultset is array of [ip_start]
DROP PROCEDURE IF EXISTS Owner2IpStarts //
CREATE DEFINER = \grave{ }ip\grave{ }@\grave{ }localhost\grave{ } PROCEDURE Owner2IpStarts(
    IN _owner MEDIUMINT UNSIGNED)
BEGIN
  SELECT ip
    FROM Ips
    WHERE owner = _owner
    ORDER BY ip;
END //
```

Given an owner, find the ranges it owns:

```
-- Resultset is array if [ip_start, ip_end]
DROP PROCEDURE IF EXISTS Owner2IpRanges //
CREATE DEFINER = \grave{ }ip\grave{ }@\grave{ }localhost\grave{ } PROCEDURE Owner2IpRanges(
    IN _owner MEDIUMINT UNSIGNED)
BEGIN
  SELECT ip AS ip_start,
      IpEnd(ip) AS ip_end
    FROM IpS
    WHERE owner = _owner
    ORDER BY ip;
END //
```

IPv6 Reference Implementation:

The first table is identified as “Ips” and includes “ip” as the first column (e.g. the ranges of IP addresses) and the identifier is labeled as “owner.” The implementation may be similar to the IPv4 implementation discussed above. The “ip” values may be BINARY (16) in the table Ips. The “ip” values exposed to the user are BINARY (32), the HEX of the BINARY (16). The “owner” values are INT UNSIGNED (but it could be something else). Also, ip+1 and ip−1 may be rather complex. IP addresses may be passed as HEX strings and HEX( ) and UNHEX( ) may be used when touching Ips.ip, which is BINARY (16).

Rules for “ip” values include:

A NULL value for ip means “greater than ‘FF . . . FF’.

A “block” of ip addresses is represented as the start and end values.

owner=0 means “not owned by anyone” or “free”.

The table may not represent overlapping blocks.

Rules for “owner” values include:

```
  * ″owner″ is the PRIMARY KEY in another table.
  * The main table (Ips) contains one row per block.
  Table generation for IP handling:
CREATE TABLE Ips (
  ip BINARY(16) NOT NULL COMMENT ″IPv6 starting address -
  UNHEX(′...′)″,
  owner INT UNSIGNED NOT NULL COMMENT ′0=not owned;
  Join to another table
to get info on owner′,
  PRIMARY KEY(ip),
  INDEX(owner) -- for finding range(s) owned
) ENGINE=InnoDB;
-- InnoDB was deliberately chosen for its ′clustering′ on the PK.
-- The table MUST be initialized with the starting IP and owner=0
INSERT INTO Ips (ip, owner) VALUES
(UNHEX(′00000000000000000000000000000000′), 0);
DELIMITER //
```

Add 1 to an IP:

```
-- Hex in, Hex out.
DROP FUNCTION IF EXISTS IpIncr //
CREATE DEFINER = \grave{ }ip\grave{ }@\grave{ }localhost\grave{ } FUNCTION IpIncr(
    _ip BINARY(32) -- hex
  ) RETURNS BINARY(32)
  DETERMINISTIC
CONTAINS SQL -- SQL but does not read or write
BEGIN
  DECLARE _non_f VARCHAR(32) DEFAULT
  RTRIM(REPLACE(_ip, ′f′, ′ ′));
  DECLARE _len INT DEFAULT LENGTH(_non_f);
  IF (_len = 0) THEN
    RETURN NULL; -- all f... +1 => null
  ELSE
    RETURN
      CONCAT( LEFT(_ip, _len - 1),
        CONV(CONV(RIGHT(_non_f, 1), 16, 10) + 1, 10, 16),
        REPEAT(′0′, 32 - _len));
  END IF;
END //
-- not as fast: LEFT(′00000000000000000000000000000000′,
32 - _len));
```

Subtract 1 from an IP:

```
-- (Please do not feed 0 in)
DROP FUNCTION IF EXISTS IpDecr //
CREATE DEFINER = \grave{ }ip\grave{ }@\grave{ }localhost\grave{ } FUNCTION IpDecr(
    _ip BINARY(32) -- hex
  ) RETURNS BINARY(32)
  DETERMINISTIC
CONTAINS SQL -- SQL but does not read or write
BEGIN
  DECLARE _non_0 VARCHAR(32) DEFAULT
  RTRIM(REPLACE(_ip, ′0′, ′ ′));
  DECLARE _len INT DEFAULT LENGTH(_non_0);
  IF (_ip IS NULL) THEN
    RETURN ′FFFFFFFFFFFFFFFFFFFFFFFFFFFFFFFF′;
  ELSE
    RETURN
      CONCAT( LEFT(_ip, _len - 1),
        CONV(CONV(RIGHT(_non_0, 1), 16, 10) - 1, 10, 16),
        REPEAT(′f′, 32 - _len));
  END IF;
END //
```

Assign a range of IP addresses to an owner:

```
-- This version does not return any information about current owner(s)
-- of the range. Any checks need to be done separately.
-- 1-7 SQL statements executed; most hit only one row.
-- To ′free′ up a block, assign it owner=0.
DROP PROCEDURE IF EXISTS IpStore //
CREATE DEFINER = \grave{ }ip\grave{ }@\grave{ }localhost\grave{ } PROCEDURE IpStore(
    IN _ipa BINARY(32),
    IN _ipz BINARY(32),
    IN _new_owner INT UNSIGNED)
BEGIN
  DECLARE _bipa BINARY(16) DEFAULT UNHEX(_ipa);
  DECLARE _bipz BINARY(16) DEFAULT UNHEX(_ipz);
  DECLARE _bip BINARY(16);
  DECLARE _owner INT UNSIGNED;
  DECLARE _bnext BINARY(16) DEFAULT UNHEX(IpIncr(_ipz));
  -- All work is done in BINARY(16), thereby avoiding case
  -- folding issues with HEX values compared in binary.
  IF (_bnext IS NULL) THEN
    -- _ipz is ff...ff
    SELECT ip, owner INTO _bip, _owner FROM Ips WHERE ip <=
    _bipz ORDER
BY ip DESC LIMIT 1;
  ELSE
    -- Deal with point just off the end (_bnext):
    SELECT ip, owner INTO _bip, _owner FROM Ips WHERE ip <=
    _bnext ORDER
BY ip DESC LIMIT 1;
    IF (_bip = _bnext) THEN
      -- No gap before next block, so may need to coalesce:
      IF (_owner = _new owner) THEN -- Merge with new entry
        DELETE FROM Ips WHERE ip = _bnext;
      END IF;
      SELECT ip, owner INTO _bip, _owner FROM Ips WHERE ip <=
      _bipz ORDER
BY ip DESC LIMIT 1;
    ELSE
      -- Assign gap:
      IF (_owner != _new_owner) THEN
        INSERT INTO Ips (ip, owner) VALUES (_bnext, _owner);
      END IF;
    END IF;
  END IF;
  -- Gut the middle (if needed):
  IF (_bip > _bipa) THEN
    DELETE FROM Ips WHERE ip > _bipa AND ip <= _bipz;
    SELECT ip, owner INTO _bip, _owner FROM Ips WHERE ip <=
    _bipa ORDER
BY ip DESC LIMIT 1;
  END IF;
  -- Deal with start of this block
  IF (_owner != _new_owner) THEN
    IF (_bip = _bipa) THEN
      SELECT owner INTO _owner FROM Ips WHERE ip < _bipa
      ORDER BY ip
DESC LIMIT 1;
      IF (_owner = _new_owner) THEN
        DELETE FROM Ips WHERE ip = _bipa; -- merge
      ELSE
        UPDATE Ips SET owner = _new_owner WHERE ip =
        _bipa; -- change
      END IF;
    ELSE
      INSERT INTO Ips (ip, owner) VALUES
      (_bipa, _new_owner); -- split
    END IF;
  END IF;
END //
```

Given a single IP address, find the owner:

```
-- Result may be 0 (un-owned), but will not be NULL.
DROP FUNCTION IF EXISTS IpOwner //
CREATE DEFINER = \grave{ }zip\grave{ }@\grave{ }localhost\grave{ } FUNCTION IpOwner(
    _ip BINARY(32))
  RETURNS INT UNSIGNED
BEGIN
  DECLARE _owner INT UNSIGNED;
  SELECT owner INTO _owner
    FROM Ips
    WHERE ip <= UNHEX(_ip)
    ORDER BY ip DESC
    LIMIT 1;
  RETURN _owner;
END //
```

Given a range of IP addresses, find all the owners:

```
DROP PROCEDURE IF EXISTS IpRangeOwners //
CREATE DEFINER = \grave{ }zip\grave{ }@\grave{ }localhost\grave{ } PROCEDURE IpRangeOwners(
    IN _ip_start BINARY(32),
    IN _ip_end BINARY(32))
-- _ip_start..ip_end is the range
-- Resultset has one owner per row.
BEGIN
  ( SELECT owner
    FROM Ips
    WHERE ip <= UNHEX(_ip_start)
    ORDER BY ip DESC
    LIMIT 1 )
  UNION DISTINCT
  ( SELECT owner
    FROM Ips
    WHERE ip > UNHEX(_ip_start)
      AND ip <= UNHEX(_ip_end) );
END //
```

Given a range of IP addresses, find blocks and owners:

```
DROP PROCEDURE IF EXISTS IpFindRanges //
CREATE DEFINER = \grave{ }zip\grave{ }@\grave{ }localhost\grave{ } PROCEDURE IpFindRanges(
    IN _ip_start BINARY(32),
    IN _ip_end BINARY(32))
-- _ip_start is start of the range
-- _ip_next is the addr after the end of the range
(or NULL when wanting to end at fff...)
-- Resultset contains array of [starting IP, owner]
-- First IP will be <= _ip_start, and may be strictly <.
-- Owners with disjoint blocks will show up multiple times.
BEGIN
  ( SELECT HEX(ip), owner
    FROM Ips
    WHERE ip <= UNHEX(_ip_start)
    ORDER BY ip DESC
    LIMIT 1 )
  UNION ALL
  ( SELECT HEX(ip), owner
    FROM Ips
    WHERE ip > UNHEX(_ip_start)
      AND ip <= UNHEX(_ip_end)
    ORDER BY ip );
END //
```

Given an IP, find the start of the next block:

```
-- Returns NULL if runs off end of list.
DROP FUNCTION IF EXISTS IpNext //
CREATE DEFINER = \grave{ }ip\grave{ }@\grave{ }localhost\grave{ } FUNCTION IpNext(
    _ipa BINARY(32) -- hex
  ) RETURNS BINARY(32)
  DETERMINISTIC
CONTAINS SQL -- SQL but does not read or write
BEGIN
  DECLARE _ipz BINARY(32);
  SELECT HEX(ip) INTO _ipz
    FROM Ips
    WHERE ip > UNHEX(_ipa)
    ORDER BY ip
    LIMIT 1;
  RETURN _ipz;
END //
```

Given an IP, find the end of the block containing the IP:

```
DROP FUNCTION IF EXISTS IpEnd //
CREATE DEFINER = \grave{ }ip\grave{ }@\grave{ }localhost\grave{ } FUNCTION IpEnd(
    _ipa BINARY(32) -- hex
  ) RETURNS BINARY(32)
  DETERMINISTIC
CONTAINS SQL -- SQL but does not read or write
BEGIN
  DECLARE _ipz BINARY(32);
  SELECT HEX(ip) INTO _ipz
    FROM Ips
    WHERE ip > UNHEX(_ipa)
    ORDER BY ip
    LIMIT 1;
  -- If off the end, SELECT returns NULL, then IpDecr turns it into ff...ff
  RETURN IpDecr(_ipz);
END //
```

Given an owner, find the starting IP for each block it owns:

```
-- Resultset is array if [ip_start]
DROP PROCEDURE IF EXISTS Owner2IpStarts //
CREATE DEFINER = \grave{ }zip\grave{ }@\grave{ }localhost\grave{ } PROCEDURE Owner2IpStarts(
    IN _owner INT UNSIGNED)
BEGIN
  SELECT HEX(ip)
    FROM Ips
    WHERE owner = _owner
    ORDER BY ip;
END //
```

Given an owner, find the ranges it owns:

```
-- Resultset is array if [ip_start, ip_end]
DROP PROCEDURE IF EXISTS Owner2IpRanges //
CREATE DEFINER = \grave{ }zip\grave{ }@\grave{ }localhost\grave{ } PROCEDURE Owner2IpRanges(
  IN _owner INT UNSIGNED)
BEGIN
  SELECT HEX(ip) AS ip_start,
    IpEnd(HEX(ip)) AS ip_end
  FROM Ips
  WHERE owner = _owner;
END //
```

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

What is claimed is:

1. A database for storing metadata corresponding to ranges, the database comprising:
a first table comprising a value from each of the ranges and an identifier for each of the ranges that corresponds to the value for each of the ranges, wherein the ranges are not overlapping and continuous by including null values for any empty ranges; and
a second table comprising the identifiers from the first table along with the metadata corresponding to each of the identifiers.

2. The database of claim 1 further comprising:
a table generator for generating the first table and generating the second table.

3. The database of claim 1 further comprising:
a receiver for receiving a query request for data stored in the database.

4. The database of claim 3 wherein the query request comprises a request for the metadata corresponding to one of the ranges.

5. The database of claim 4 wherein the database is configured to access the identifier for the requested range from the first table and return the requested metadata corresponding to the accessed identifier from the second table.

6. The database of claim 3 wherein the receiver is operative to receive instructions for modifying the data stored in the database.

7. The database of claim 6 wherein instructions for modifying the database comprise incrementing or decrementing a range.

8. The database of claim 1 wherein the value comprises either a starting value of the range or an ending value of the range.

9. The database of claim 1 wherein multiple ranges can be associated with a single one of the identifiers.

10. The database of claim 9 wherein second table comprises fewer entries than the first table when at least two of the ranges are associated with a single one of the identifiers.

11. A computerized method with a database that optimizes query requests for ranges, the method comprising:
generating a first table comprising a list of non-overlapping and continuous ranges and an identifier for each of the ranges, wherein the ranges are not overlapping and continuous by including zero values for any empty ranges;
generating a second table comprising the identifiers from the first table along with data to be stored for each of the identifiers; and
accessing, in response to one of the query requests, the stored data for a requested range by locating the requested range in the first table and using the requested range's identifier to access the stored data corresponding to that identifier.

12. A computer system comprising:
a database storing data that is associated with one or more ranges, the database comprising:
a first table comprising the ranges and an identifier corresponding with each of the ranges, wherein the ranges are continuous and not overlapping; and
a second table comprising the identifiers and the stored data, wherein the stored data is associated with the identifier that corresponds with the range;
a processor coupled with the database for handling query requests relating to stored data and modifying the tables.

13. The computer system of claim 12 wherein the continuity is ensured by inclusion of ranges that are not associated with any of the stored data.

14. The computer system of claim 13 wherein the ranges that are not associated with any of the stored data are zero table entries.

15. The computer system of claim 12 wherein each of the ranges are identified in the first table by either a starting value of the range or an ending value of the range.

16. The computer system of claim 12 wherein the query requests comprise at least one request for the data that is associated with at least one of the ranges.

17. The computer system of claim 16 wherein the processor is configured to access the identifier for the requested range from the first table and return the requested data associated with the accessed identifier from the second table.

18. The computer system of claim 12 wherein the query requests comprise instructions for modifying the data stored in the database.

19. The computer system of claim 12 wherein multiple ranges are associated with a same one of the identifiers.

20. The computer system of claim 19 wherein the number of identifiers is less than the number of ranges in the first table when at least two of the ranges are associated with the same one of the identifiers.
